(19) United States
(12) Patent Application Publication
(10) Pub. No.: US 2024/0356715 A1
(43) Pub. Date: Oct. 24, 2024

(54) ADAPTIVE UPLINK TRANSMISSION SKIPPING

(71) Applicant: QUALCOMM Incorporated, San Diego, CA (US)

(72) Inventors: Sitaramanjaneyulu KANAMARLAPUDI, San Diego, CA (US); Leena ZACHARIAS, San Jose, CA (US); Harshit CHATURVEDI, San Marcos, CA (US)

(21) Appl. No.: 18/617,515

(22) Filed: Mar. 26, 2024

Related U.S. Application Data
(60) Provisional application No. 63/497,974, filed on Apr. 24, 2023.

(51) Int. Cl. H04L 5/00; H04W 72/23; H04W 72/542

(52) U.S. Cl. CPC H04L 5/0087; H04L 5/0055; H04W 72/23; H04W 72/542

(57) ABSTRACT

Methods, systems, and devices for wireless communications are described. A user equipment (UE) may receive control signaling configuring the UE to skip uplink transmission when the UE does not have data to transmit. The UE may receive a grant for uplink resources. In some examples, the grant may be a configured grant or a dynamic grant. The UE transmit, when the UE does not have data to transmit, an uplink message via the uplink resources based on traffic characteristics of the UE, the uplink message comprising null data.

### CROSS REFERENCE

The present application for patent claims the benefit of U.S. Provisional Patent Application No. 63/497,974 by KANAMARLAPUDI et al., entitled “ADAPTIVE UPLINK TRANSMISSION SKIPPING,” filed Apr. 24, 2023, assigned to the assignee hereof, and expressly incorporated by reference herein.

### FIELD OF TECHNOLOGY

The following relates to wireless communications, including adaptive uplink transmission skipping.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support adaptive uplink transmission skipping. For example, the described techniques provide for a user equipment (UE) to adaptively or dynamically disable a configuration to skip uplink transmission. A UE may be configured to skip an uplink transmission if the UE does not have any uplink data to improve UE power aspects. For example, even if the UE is scheduled with uplink resources dynamically or via a configured grant, the UE may skip the uplink transmission to a network entity if the UE does not have any information to transmit. While skipping the uplink transmission may reduce unnecessary transmissions, the network entity may adjust scheduling periodicity for the UE based on the UE having skipped the uplink transmission. The techniques described herein provide for a UE that is configured to skip uplink transmissions to send an uplink message with null data to prevent scheduling changes for the UE. For example, the UE may dynamically disable the configuration to skip uplink transmissions. The UE may disable the configuration to skip uplink transmissions based on traffic characteristics or requirements. For example, if the UE is operating with certain traffic types, the UE may transmit uplink messages with null data despite being configured to skip uplink transmissions. Additionally, or alternatively, if the UE is operating with applications which require low latency or have specific grant periodicities, the UE may transmit uplink messages with null data. In some examples, if applications at the UE are not satisfying throughput or latency requirements, the UE may transmit uplink messages with null data, such as to prevent latency or throughput metrics from further degrading.

A method for wireless communications at a UE is described. The method may include receiving control signaling configuring the UE to skip uplink transmission when the UE does not have data to transmit, receiving a grant for uplink resources, and transmitting, when the UE does not have data to transmit, an uplink message via the uplink resources based on traffic characteristics of the UE or a type of an application operating at the UE, the uplink message including null data.

A UE for wireless communications is described. The UE may include one or more memories storing processor-executable code and one or more processors coupled with the one or more memories. The one or more processors may individually or collectively be operable to execute the code to cause the UE to receive control signaling configuring the UE to skip uplink transmission when the UE does not have data to transmit, receive a grant for uplink resources, and transmit, when the UE does not have data to transmit, an uplink message via the uplink resources based on traffic characteristics of the UE or a type of an application operating at the UE, the uplink message including null data.

Another apparatus for wireless communications at a UE is described. The apparatus may include means for receiving control signaling configuring the UE to skip uplink transmission when the UE does not have data to transmit, means for receiving a grant for uplink resources, and means for transmitting, when the UE does not have data to transmit, an uplink message via the uplink resources based on traffic characteristics of the UE or a type of an application operating at the UE, the uplink message including null data.

A non-transitory computer-readable medium storing code for wireless communications at a UE is described. The code may include instructions executable by a processor to receive control signaling configuring the UE to skip uplink transmission when the UE does not have data to transmit, receive a grant for uplink resources, and transmit, when the UE does not have data to transmit, an uplink message via the uplink resources based on traffic characteristics of the UE or a type of an application operating at the UE, the uplink message including null data.

In some examples of the method, apparatuses, and non-transitory computer-readable medium described herein, transmitting the uplink message may include operations, features, means, or instructions for transmitting the uplink message based on the type of the application operating at the UE, where the traffic characteristics include the type of the application.

In some examples of the method, UE, apparatuses, and non-transitory computer-readable medium described herein, the application operating at the UE discards one or more packets based on a latency requirement of the application.

Some examples of the method, UE, apparatuses, and non-transitory computer-readable medium described herein may further include operations, features, means, or instructions for discarding packets for an application at a rate above a threshold, where transmitting the uplink message may be based on the rate being above the threshold.

In some examples of the method, UE, apparatuses, and non-transitory computer-readable medium described herein, transmitting the uplink message may include operations, features, means, or instructions for transmitting the uplink message based on a traffic type of traffic associated with a flow of the UE, where the traffic characteristics include the traffic type.

In some examples of the method, UE, apparatuses, and non-transitory computer-readable medium described herein, the traffic type is based on header information of the traffic.

In some examples of the method, UE, apparatuses, and non-transitory computer-readable medium described herein, transmitting the uplink message may include operations, features, means, or instructions for transmitting the uplink message based on a latency requirement for traffic of the UE, where the traffic characteristics include the latency requirement.

In some examples of the method, UE, apparatuses, and non-transitory computer-readable medium described herein, transmitting the uplink message may include operations, features, means, or instructions for transmitting the uplink message based on a packet discard timer at the UE being active.

In some examples of the method, UE, apparatuses, and non-transitory computer-readable medium described herein, transmitting the uplink message may include operations, features, means, or instructions for transmitting the uplink message based on a Packet Data Convergence Protocol (PDCP) Protocol Data Unit (PDU) recovery procedure at the UE.

In some examples of the method, UE, apparatuses, and non-transitory computer-readable medium described herein, transmitting the uplink message may include operations, features, means, or instructions for transmitting the uplink message based on the UE performing a Transmission Control Protocol slow start procedure, where the traffic characteristics include the Transmission Control Protocol slow start procedure.

In some examples of the method, UE, apparatuses, and non-transitory computer-readable medium described herein, transmitting the uplink message may include operations, features, means, or instructions for transmitting the uplink message based on the UE performing a duplicate acknowledgment procedure, where the traffic characteristics include the duplicate acknowledgment procedure.

Some examples of the method, UE, apparatuses, and non-transitory computer-readable medium described herein may further include operations, features, means, or instructions for measuring reference signals to obtain a reference signal received power measurement, where transmitting the uplink message may be based on the reference signal received power measurement failing to satisfy a threshold, and where the traffic characteristics include the reference signal received power measurement failing to satisfy the threshold.

Some examples of the method, UE, apparatuses, and non-transitory computer-readable medium described herein may further include operations, features, means, or instructions for measuring reference signals to obtain a pathloss measurement, where transmitting the uplink message may be based on the pathloss measurement failing to satisfy a threshold, and where the traffic characteristics include the pathloss measurement failing to satisfy the threshold.

In some examples of the method, UE, apparatuses, and non-transitory computer-readable medium described herein, transmitting the uplink message may include operations, features, means, or instructions for transmitting the uplink message based on satisfying a Radio Link Control (RLC) retransmission threshold, where the traffic characteristics include the satisfying the RLC retransmission threshold.

In some examples of the method, UE, apparatuses, and non-transitory computer-readable medium described herein, transmitting the uplink message may include operations, features, means, or instructions for transmitting the uplink message based on the traffic characteristics satisfying thresholds associated with mobility procedures at the UE.

In some examples of the method, UE, apparatuses, and non-transitory computer-readable medium described herein, receiving the grant may include operations, features, means, or instructions for receiving a dynamic grant indicating the uplink resources for the uplink transmission, where the grant includes the dynamic grant.

In some examples of the method, UE, apparatuses, and non-transitory computer-readable medium described herein, receiving the grant may include operations, features, means, or instructions for receiving a configured grant indicating periodic uplink resources, where the uplink resources for the uplink transmission correspond to an occasion of the periodic uplink resources.

Some examples of the method, UE, apparatuses, and non-transitory computer-readable medium described herein may further include operations, features, means, or instructions for transmitting the uplink message based on a determination that the UE is operating in a first state of multiple states, the multiple states including a small data transmission state and a non-small data transmission state.

### BRIEF DESCRIPTION OF THE DRAWINGS

FIG. 1 shows an example of a wireless communications system that supports adaptive uplink transmission skipping in accordance with one or more aspects of the present disclosure.

FIG. 2 shows an example of a wireless communications system that supports adaptive uplink transmission skipping in accordance with one or more aspects of the present disclosure.

FIG. 3 shows an example of a process flow that supports adaptive uplink transmission skipping in accordance with one or more aspects of the present disclosure.

FIGS. 4 and 5 show block diagrams of devices that support adaptive uplink transmission skipping in accordance with one or more aspects of the present disclosure.

FIG. 6 shows a block diagram of a communications manager that supports adaptive uplink transmission skipping in accordance with one or more aspects of the present disclosure.

FIG. 7 shows a diagram of a system including a device that supports adaptive uplink transmission skipping in accordance with one or more aspects of the present disclosure.

FIGS. 8 through 10 show flowcharts illustrating methods that support adaptive uplink transmission skipping in accordance with one or more aspects of the present disclosure.

### DETAILED DESCRIPTION

A user equipment (UE) may be configured to skip an uplink transmission if the UE does not have any uplink data to improve UE power aspects. For example, even if the UE is scheduled with uplink resources dynamically or via a configured grant, the UE may skip the uplink transmission to a network entity if the UE does not have any information to transmit. While skipping the uplink transmission may reduce unnecessary transmissions, the network entity may adjust scheduling periodicity for the UE based on the UE having skipped the uplink transmission. For example, the network entity may detect a change to a resource usage pattern, and the network entity may increase a periodicity of granted resources for uplink transmissions. This increase in duration between resource occasions may increase latency and may impact performance for low latency applications or Quality of Service (QOS) flows at the UE with stringent requirements.

A UE that is configured to skip uplink transmissions may send an uplink message with null data (e.g., no protocol data units (PDUs), PDUs including padding data) to prevent scheduling changes for the UE. For example, the UE may dynamically disable the configuration to skip uplink transmissions. The UE may disable the configuration to skip uplink transmissions based on traffic characteristics or requirements. For example, if the UE is operating with certain traffic types, the UE may transmit uplink messages with null data despite being configured to skip uplink transmissions. Additionally, or alternatively, if the UE is operating with applications which require low latency or have specific grant periodicities, the UE may transmit uplink messages with null data. In some examples, if applications at the UE are not satisfying throughput or latency requirements, the UE may transmit uplink messages with null data, such as to prevent latency or throughput metrics from further degrading.

Aspects of the disclosure are initially described in the context of wireless communications systems. Aspects of the disclosure are further illustrated by and described with reference to apparatus diagrams, system diagrams, and flowcharts that relate to adaptive uplink transmission skipping.

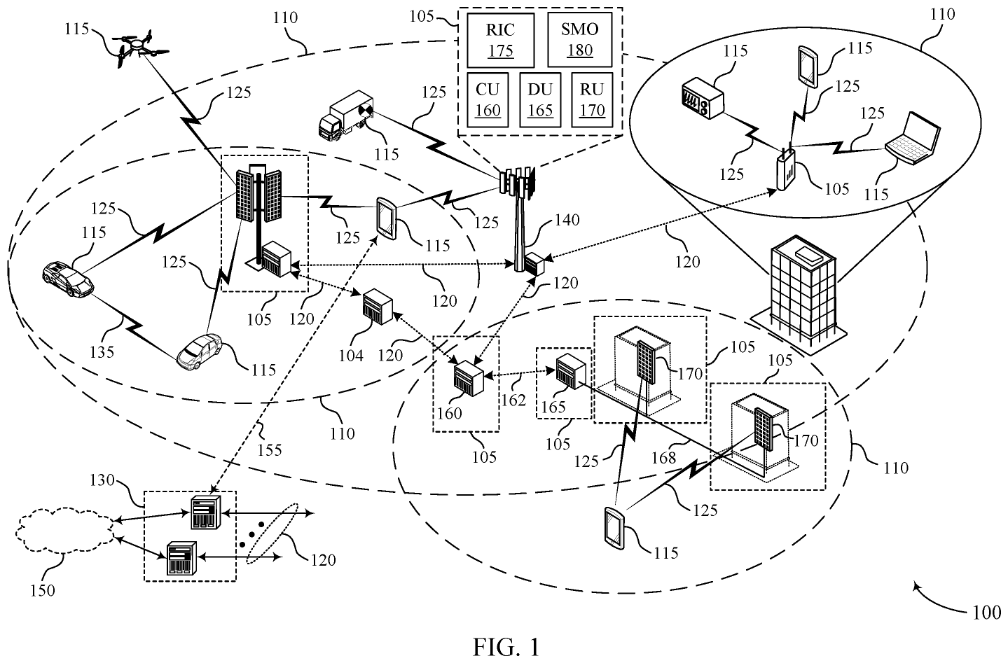

FIG. 1 shows an example of a wireless communications system 100 that supports adaptive uplink transmission skipping in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (cNB), a next-generation NodeB or a giga-NodeB (either of which may be referred to as a gNB), a 5G NB, a next-generation eNB (ng-eNB), a Home NodeB, a Home cNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support adaptive uplink transmission skipping as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support techniques for a UE 115 to skip an uplink transmission to a network entity 105 if the UE 115 does not have any data or control information to transmit to the network entity 105. Skipping the uplink transmission may improve UE power consumption, reduce radio resources over-the-air or indirectly reduce interference in a cell provided by the network entity 105.

In some examples, the network entity 105 may configure the UE 115 with one or more different configurations for skipping an uplink transmission. For example, the network entity 105 may configure the UE 115 with a configuration to skip uplink transmissions (e.g., a dynamic skip uplink transmission) or an enhanced configuration to skip uplink transmissions (e.g., enhanced skip uplink transmission), or both. In some examples, when the UE 115 is configured with either configuration, the UE 115 may skip an uplink MAC transport block transmission. In some examples, the UE 115 may transmit a buffer status report including only padding bits if the UE 115 does not have data to transmit via uplink signaling. If the UE 115 is configured with the enhanced skip uplink configuration, the UE 115 may not use a configured grant for the UE 115 (e.g., if one or more conditions of the enhanced skip uplink configuration are satisfied).

In some examples, the wireless communications system 100 may support scheduling resources dynamically or in accordance with some configured scheduling, such as semi-persistent scheduling (SPS) or a configured grant. The wireless communications system 100 may use a MAC-based configured grant mechanism for quick adaptation or pseudo-periodic uplink dynamic grants, which may have resource patterns similar to a configured grant, to meet specific QoS flow requirements or application requirements. In some examples, implementing a configured grant pattern based on RRC signaling may be complex unless the application and an OTA configuration match to meet QoS requirements for the application.

By configuring a UE 115 to skip an uplink transmission, the network may identify grants which are not fully utilized (e.g., at the Physical layer) to adjust for pseudo-dynamic grant periodicity. The network entity 105 may adjust the scheduling of grants or a periodicity of pseudo-dynamic grants to the UE 115 to balance grant management and meeting the QoS requirements of the application.

In some examples, a network entity 105 may schedule a UE 115 using dynamic grants with a pseudo-periodic manner to satisfy UE-specific QoS requirements and to support the skip uplink configuration. Using dynamic grants may provide additional flexibility for dynamic resource allocation using dynamic grants to various UEs 115 without the semi-persistent configuring, enabling, or disabling of MAC CE-based configured grants or RRC-based configured grants.

While the skip uplink configuration may reduce transmissions from the UE perspective to improve power efficiency and other key performance indicators, the network (e.g., a network entity 105 serving a UE 115) may adjust the configured grant periodicity dynamically for the UE 115 based on resource usage patterns. For example, if the UE 115 skips an uplink transmission, a resource usage pattern of the UE 115 may indicate to the network that the UE 115 does not need as frequent of scheduling. The network entity 105 may then increase the periodicity between resources for the UE 115. For example, the network entity 105 may transmit a dynamic grant to the UE 115 every X milliseconds. If the UE 115 skips an uplink transmission, the network entity may adjust the scheduling frequency, and the network entity 105 may transmit a dynamic grant to the UE 115 every 2× milliseconds after the UE 115 skips the uplink transmission. In some examples, the network entity 105 may continue transmit dynamic grants to the UE 115 every 2× milliseconds until the UE 115 transmits new data to the network entity 105. If the network entity 105 receives new data from the UE 115, the network entity 105 may again transmit dynamic grants to the UE 115 every X milliseconds. In some examples, the UE 115 may transmit a scheduling request based on the periodicity of the dynamic grants changing.

While adjusting the periodicity of dynamic grants may improve radio resource management and UE power aspects, it may have adverse effects when a UE 115 is operating with specific traffic patterns that have stringent QoS requirements or operating under some radio conditions. For example, the UE 115 may operate an application which performs latency benchmarks or QoS benchmarks, and adjusting the dynamic grant periodicity may affect the benchmark performance. Additionally, or alternatively, the UE 115 may operate a low latency application which uses high priority, low latency traffic, which may be transmitted at a different periodicity compared to the dynamic grant periodicity. Adjusting the dynamic grant periodicity after the UE 115 skips an uplink transmission may result in higher latency for the application and not satisfying QoS requirements for the application. In some examples, the UE 115 may have tighter latency requirements for a QoS flow, which may result indirectly in a smaller PDCP discard timer. The UE 115 may discard packets in the PDCP, resulting in the UE 115 skipping an uplink transmission and the later PDUs being delayed. In some examples, the UE 115 may be operating on a cell edge, and the UE 115 may lose or not receive physical downlink control channel (PDCCH) signaling, and the network entity 105 may interpret the lost PDCCH as a skipped uplink transmission, which may decrease signaling throughput at the UE 115. Additionally, or alternatively, the change in grant periodicity may result in a scheduling request procedure (e.g., including the UE 115 transmitting a scheduling request), which may further increase latency for the UE 115 to receive a grant scheduling resources.

A device in the wireless communications system 100 may support transmitting a message with null data when the device is configured to skip transmissions and has no pending data. For example, a UE 115 may be configured to skip an uplink transmission to a network entity 105 when the UE 115 has no data to transmit. However, the UE 115 may transmit an uplink message with null data (e.g., no PDUs, padding PDUs), which may prevent the network entity 105 from changing a dynamic grant periodicity for the UE 115. In some examples, the UE 115 may transmit the uplink message with null data based on traffic characteristics or channel characteristics at the UE 115. For example, if the UE 115 is operating with certain traffic types or is supporting applications with stringent reliability or latency requirements, the UE 115 may transmit an uplink message with null data (despite being configured to skip uplink transmission when the UE 115 has no data). In some examples, the UE 115 may disable (e.g., temporarily disable) the configuration of the UE 115 to skip an uplink transmission when the UE 115 has no data, which may enable the UE 115 to transmit an uplink message with null data or no data. In some examples, a UE 115, configured to skip uplink transmission when the UE 115 has no data, may transmit an uplink message with null data using resources that are scheduled dynamically (e.g., via a dynamic grant) or semi-persistently (e.g., via a configured grant). Additionally, while some aspects of these techniques are described with reference to a UE 115 transmitting an uplink data message with null data, these techniques may also be implemented by other wireless devices. For example, a network entity 105 may transmit a downlink message with null data.

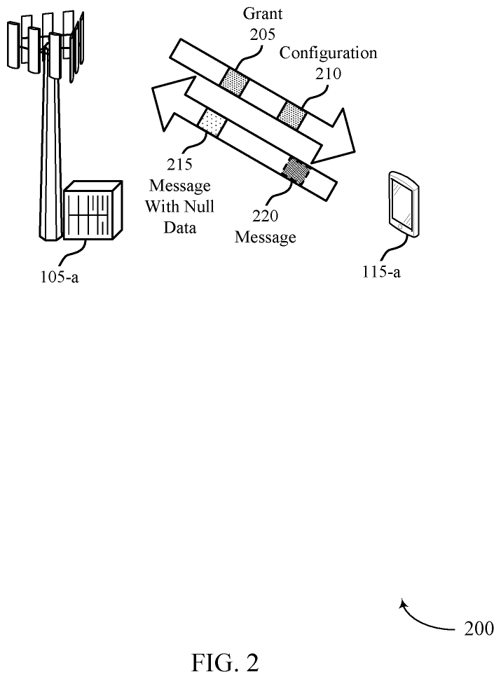

FIG. 2 shows an example of a wireless communications system 200 that supports adaptive uplink transmission skipping in accordance with one or more aspects of the present disclosure. The wireless communications system 200 may implement some aspects of a wireless communications system 100. The wireless communications system 200 may include a UE 115-a and a network entity 105-a, which may be respective examples of a UE 115 and a network entity 105 of the wireless communications system 100.

The network entity 105-a may transmit a grant 205 to schedule uplink resources for the UE 115-a. In some examples, the grant 205 may be an example of a configured grant, which schedules periodic uplink resources for the UE 115-a. For example, a single configured grant may schedule multiple periodic resources for the UE 115-a. In some other examples, the grant 205 may be an example of a dynamic grant. For example, the network entity 105-a may transmit a dynamic grant to dynamically schedule uplink resources for the UE 115-a. In some cases, the network entity 105-a may pseudo-periodically transmit dynamic grants to the UE 115-a to schedule uplink resources, which may provide some flexibility while providing consistent resources for the UE 115-a to meet QoS requirements.

The UE 115-a may be configured to skip uplink transmissions when the UE 115-a does not have uplink data or uplink control information. In some examples, the network entity 105-a may transmit control signaling configuring the UE 115-a to skip an uplink transmission if the UE 115-a does not have pending data or control information to transmit. For example, the network entity 105-a may transmit a configuration 210 to the UE 115-a, which may configure the UE 115-a to skip an uplink MAC transport block transmission if the UE 115-a does not have uplink data, even if the UE 115-a has been granted resources. In some examples, the UE 115-a may be configured to refrain from transmitting an uplink message via resources granted by a configured grant or resources granted by a dynamic grant.

If the UE 115-a skips an uplink transmission to the network entity 105-a, the network entity 105-a may adjust a periodicity at which the UE 115-a is granted resources. For example, if the network entity 105-a is transmitting quasi-periodic grants to the UE 115-a to provide uplink resources, the network entity 105-a may increase the periodicity between the quasi-periodic grants based on not receiving an uplink message from the UE 115-a. The network entity 105-a may modify resource scheduling for the UE 115-a based on traffic patterns or resource utilization patterns, and because the UE 115-a has skipped an uplink message, the network entity 105-a may determine that the UE 115-a can be scheduled with less frequent resources to improve power utilization at the UE 115-a and improve resource utilization in the wireless communications system 200.

The UE 115-a may operate with traffic characteristics or under conditions with stringent latency or reliability requirements. For example, a user of the UE 115-a may use an application which requires low latency communications, such as video calling. If the UE 115-a skips an uplink transmission, and the network entity 105-a adjusts a scheduling periodicity for the UE 115-a, the UE 115-a may be unable to meet latency requirements or otherwise demanding QoS requirements for traffic of the UE 115-a or an application operating at the UE 115-a.

The wireless communications system 200 may support techniques for a UE 115, such as the UE 115-a, to disable or ignore a configuration to skip uplink transmissions. For example, although the UE 115-a is configured to skip an uplink transmission if the UE 115-a does not have data, the UE 115-a may transmit a message 215 with null data using granted uplink resources if the UE 115-a does not have any uplink data.

For example, the network entity 105-a may transmit the configuration 210 to configure the UE 115-a to skip uplink transmissions if the UE 115-a does not have uplink data. The network entity 105-a may pseudo-periodically transmit grants, such as the grant 205, to the UE 115-a to schedule uplink resources. The UE 115-a may not have data to transmit on uplink resources scheduled by the grant 205, but the UE 115-a may transmit a message with null data via the uplink resources scheduled by the grant 205. By transmitting the message with null data, the network entity 105-a may not adjust a pseudo-periodicity for transmitting grants to the UE 115-a. In some other systems, the UE 115-a may skip the uplink transmission, which may lead to the network entity 105-a changing a frequency at which the network entity 105-a transmits grants to the UE 115-a. At a next occasion, the network entity 105-a may transmit another grant using a same periodicity or pseudo-periodicity, and the UE 115-a may transmit a message 220 including data. For example, the UE 115-a may continue uplink signaling based a same periodicity or pseudo-periodicity, despite the UE 115-a not having uplink data for an uplink transmission occasion or uplink resource.

In some examples, the UE 115-a may transmit the message 215 with null data based on traffic characteristics at the UE 115-a. In some examples, the UE 115-a may transmit the message 215 with null data based on dynamically disabling the configuration to skip an uplink transmission of the UE 115-a does not have pending data or control information to transmit.

For example, the UE 115-a may transmit the message 215 with null data based on the UE 115-a operating with or communicating certain traffic types. In some examples, the UE 115-a may transmit the message 215 with null data based on a traffic type of traffic at the UE 115-a being associated with benchmark tests for latency or reliability. Additionally, or alternatively, the traffic or traffic type may be associated with customer-requested or customer-negotiated flows (e.g., QoS flows).

In some cases, the UE 115-a may identify a traffic type of an application or traffic based on information included in a header of a packet associated with the application or traffic. For example, a QoS flow or an application may be configured at the UE 115-a, and the U115-a may have transmitted data packets for the QoS flow or the application. A data packet may include a header with header information that is indicative of, for example, protocol information, traffic characteristics, congestion information, and the like for the QoS flow or the application. In some examples, the header of the data packet may include an internet protocol tuple, which may include internet protocol information for the data packet. In some examples, the header may indicate whether the data packet includes Real time Transport Protocol (RTP) traffic, User Datagram Protocol (UDP) traffic, Transmission Control Protocol (TCP), general packet radio service (GPRS) Tunneling Protocol (GTP) traffic, ethernet traffic, low latency, low loss traffic (L4S), or any combination thereof. In some examples, the UE 115-a may disable the uplink skipping configuration or transmit the message 215 with null data based on the heard information. For example, header information for a data packet associated with a QoS flow may be indicative of a protocol which periodically transmits or generates information, and the UE 115-a may transmit the message 215 with null data to maintain a periodic timing for the QoS flow. In some examples, header information for a data packet associated with an application may be indicative that the application is associated with low latency requirements, and the UE 115-a may transmit the message 215 with null data to maintain a periodic timing for the application based on the low latency requirements.

In some examples, the UE 115-a may disable the configuration to skip uplink transmission for one or more QoS flows based on a priority of signaling associated with the one or more QoS flows or latency requirements for the one or more QoS flows. For example, if an application is losing specific flows consistently, such as a pose update flow for an extended reality application, the UE 115-a may transmit the message 215 with null data.

In some examples, the UE 115-a may disable the configuration to skip uplink transmission based on whether small data transmission operation is configured at the UE 115-a. For example, the UE 115-a may transmit the message 215 with null data based on being configured for small data transmission or based on operating in a small data transmission state. In some examples, the UE 115-a may transmit the message 215 with null data based on operating in a non-small data transmission state.

In some examples, the UE 115-a may transmit the message 215 with null data based on the UE 115-a operating or using certain applications or types of applications. For example, if the UE 115-a is operating with an over-the-top (OTT), extended reality, or virtual reality application, latency for traffic at the UE 115-a may be critical or have stringent requirements. Flows for different applications may be associated with different QoS requirements, and the UE 115-a may enable or disable the configuration to skip uplink transmissions for different flows based on respective Qos requirements associated with the different flows. In some cases, a grant periodicity for these applications may not align or sync with the periodicity of a configured grant or a pseudo-periodicity of a dynamic grant. For example, if packets arrive every 40 milliseconds from the application, and the UE 115-a may receive a grant from the network entity 105-a every 30 milliseconds. If the UE 115-a skips an uplink transmission, the grant periodicity may change to every 60 milliseconds, which may significantly increase delay in packet transmission. By transmitting the message 215 with null data, the UE 115-a may mitigate delay and latency for these types of applications.

In some examples, the UE 115-a may transmit the message 215 with null data based on a packet discard timer running at the UE 115-a. For example, if timer discard is resulting in packet loss at the PDCP service data unit (SDU) level or PDCP PDU level, or packets are experiencing more than a specific latency waiting to be transmitted over-the-air, the UE 115-a may disable the skip uplink transmission functionality to prevent further packet loss or increases to latency. When the PDCP at the UE 115-a receives an uplink packet, the PDCP may start a timer. For example, the timer discard may be 50 milliseconds. The UE 115-a may either transmit the packet before the timer expires or discard the packet. A timing, periodicity, or pseudo-periodicity of grants may occur such that the UE 115-a cannot transmit the packet before the timer expires, and the UE 115-a may discard the packet. This may result in the UE 115-a not having data to transmit. However, the UE 115-a may transmit the message 215 with null data to prevent a change to the timing, periodicity, or pseudo-periodicity of the grants and prevent further packet discarding based on the discard timer. In some examples, the UE 115-a may transmit the message 215 with null data based on a packet discard quantity or packet discard rate satisfying a threshold.

In some examples, the UE 115-a may transmit the message 215 with null data based on having previously skipped an uplink transmission, and transmitting the message 215 may reset the periodicity or pseudo-periodicity. For example, the UE 115-a may transmit the message 215 responsive to discarding packets or responsive to a periodicity or pseudo-periodicity of grants changing.

In some examples, the UE 115-a may perform a PDCP PDU recovery procedure to recover PDUs, and the UE 115-a may transmit the message 215 with null data based on performing the PDCP PDU recovery procedure. For example, the UE 115-a may change to a cell provided by the network entity 105-a from another cell. During the transition, the UE 115-a may have lost packets at the PDCP level. The UE 115-a may indicate lost packets to the network entity 105-a. The network entity 105-a may obtain the lost packets from the other cell and transmit the lost packets to the UE 115-a so that the UE 115-a can process the PDUs. The UE 115-a may transmit the message 215 with null data while performing the PDCP PDU recovery to prevent any additional delays that may further extend processing of the received packets.

In some examples, the UE 115-a may perform a Transmission Control Protocol (TCP) slow start procedure, and the UE 115-a may transmit the message 215 with null data based on performing the TCP slow start procedure. Additionally, or alternatively, the UE 115-a may perform a duplicate acknowledgment procedure, and the UE 115-a may transmit the message 215 with null data based on performing the duplicate acknowledgment procedure. In some examples, the UE 115-a may be in a connection establishment phase for one or more application-level protocols (e.g., TCP handshake or ethernet signaling) or an internet protocol (IP) multimedia subsystem (IMS) signaling establishment stage.

In some examples, the UE 115-a may transmit the message 215 with null data based on radio characteristics experienced by the UE 115-a. For example, if the UE 115-a is operating in marginal radio conditions, such as where a reference signal received power (RSRP) measurement or a pathloss measurement is below a threshold, the UE 115-a may disable the configuration to skip uplink transmissions, and the UE 115-a may transmit the message 215 with null data. For example, having poor signal quality or channel quality may provide a higher probability of PDCCH loss. If the UE 115-a does not receive the PDCCH, the UE 115-a may not be scheduled for uplink resources, which may be interpreted by the network entity 105-a as a skipped uplink transmission instead of a missed PDCCH.

In some examples, the UE 115-a may be operating above an RLC retransmission threshold. The UE 115-a may transmit the message 215 with the null data based on operating above the RLC retransmission threshold, as maintaining the pseudo-periodicity or periodicity of the grants may provide for faster retransmission of the PDUs. In some examples, the UE 115-a may operate in radio conditions which are part of, or may initiate, RRC signaling procedures for mobility procedures, such as measurements, handover, or cell reselection, or other Layer 3 or non-access stratum-level signaling. By transmitting the message 215 with null data, the UE 115-a may prevent channel or signal degradation which may occur based on sparser uplink resources or a longer periodicity between uplink resources.

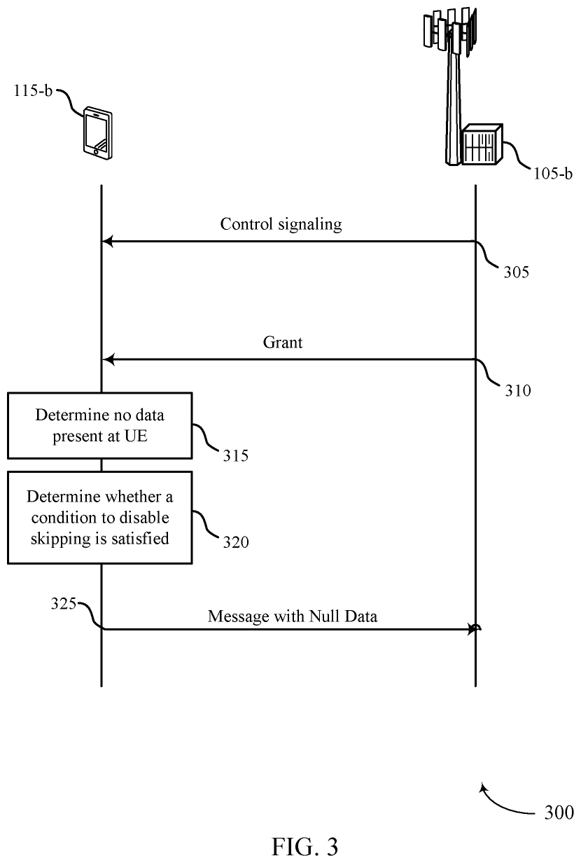

FIG. 3 shows an example of a process flow 300 that supports adaptive uplink transmission skipping in accordance with one or more aspects of the present disclosure. The process flow 300 may be implemented by a UE 115-b or a network entity 105-b, or both, which may be respective examples of a UE 115 and a network entity 105 as described with reference to FIGS. 1 and 2.

In the following description of the process flow 300, the operations between the UE 115-b and the network entity 105-b may be transmitted in a different order than the exemplary order shown, or the operations performed by UE 115-b and the network entity 105-b may be performed in different orders or at different times. Certain operations may also be left out of the process flow 300, or other operations may be added to the process flow 300.

At 305, the network entity 105-b may transmit, and the UE 115-b may receive, control signaling configuring the UE 115-b to skip uplink transmission when the UE 115-b does not have data to transmit. For example, the control signaling may indicate a configuration for the UE 115-b to skip an uplink transport block transmission if the UE 115-b does not have pending uplink control information or uplink data.

At 310, the UE 115-b may receive a grant for uplink resources. In some examples, a configured grant may be an example of the grant. The configured grant may allocate periodic uplink resources to the UE 115-b. In some examples, a dynamic grant may be an example of the grant. In some cases, the network entity 105-b may periodically, or semi-periodically, transmit dynamic grants to the UE 115-b.

The UE 115-b may be scheduled to transmit an uplink message via the uplink resources. However, the UE 115-b may determine at 315 that it does not have uplink data to transmit via the uplink resources. In some examples, the UE 115-b may determine at 320 whether the UE 115-b satisfies a condition to disable the configuration to skip uplink transmission. For example, the UE 115-b may check traffic characteristics or traffic properties for signaling or traffic at the UE 115-b, as discussed above with reference to FIG. 2, to determine whether to transmit a message including null data, despite being configured to skip uplink transmission when the UE 115-b does not have data.

At 325, the UE 115-b may transmit an uplink message including null data. For example, the UE 115-b may transmit, when the UE 115-b does not have data to transmit, an uplink message via the uplink resources based on traffic characteristics of the UE 115-b or a type of an application operating at the UE, where the uplink message includes null data. In some examples, the UE 115-b may transmit the uplink message based on a type of an application operating at the UE 115-b. In some examples, the traffic characteristics may include or be based on the type of the application. In some examples, the UE 115-b may discard packets for an application at a rate above a threshold, and the UE 115-b may transmit the uplink message based on the rate being above the threshold. In some examples, the UE 115-b may transmit the uplink message based on a traffic type of traffic associated with a flow of the UE 115-b. The traffic characteristics may include or be based on the traffic type. In some examples, the UE 115-b may transmit the uplink message based on a packet discard timer at the UE 115-b being active or based on the packet discard timer having previously expired. In some examples, the UE 115-b may transmit the uplink message based on the UE 115-b performing a PDCP PDU recovery procedure.

In some examples, the UE 115-b may transmit the uplink message including null data based on radio characteristics experienced by the UE 115-b. Having poor signal quality or channel quality may provide a higher probability of PDCCH loss. If the UE 115-b does not receive the PDCCH, the UE 115-b may not be scheduled for uplink resources, which may be interpreted by the network entity 105-a as a skipped uplink transmission instead of a missed PDCCH. For example, if the UE 115-b is operating in marginal radio conditions, such as where an RSRP measurement or a pathloss measurement is below a threshold, the UE 115-b may disable the configuration to skip uplink transmissions, and the UE 115-b may transmit the message including null data. For example, the UE 115-b may measure reference signals to obtain an RSRP measurement. The UE 115-b may transmit the uplink message based on the reference signal received power measurement failing to satisfy a threshold. In some examples, the traffic characteristics may include the reference signal received power measurement failing to satisfy the threshold. Additionally, or alternatively, the UE 115-b may measure reference signals to obtain a pathloss measurement, and the UE 115-b may transmit the uplink message based on the pathloss measurement failing to satisfy a threshold. In some examples, traffic characteristics may include or otherwise be based on the pathloss measurement failing to satisfy the threshold.

In some examples, the UE 115-b may be operating above an RLC retransmission threshold. The UE 115-b may transmit the uplink message including the null data based on operating above the RLC retransmission threshold, as maintaining the pseudo-periodicity or periodicity of the grants may provide for faster retransmission of the PDUs. In some examples, the UE 115-b may operate in radio conditions which are part of, or may initiate, RRC signaling procedures for mobility procedures, such as measurements, handover, or cell reselection, or other Layer 3 or non-access stratum-level signaling. By transmitting the uplink message with null data, the UE 115-b may prevent channel or signal degradation which may occur based on sparser uplink resources or a longer periodicity between uplink resources.

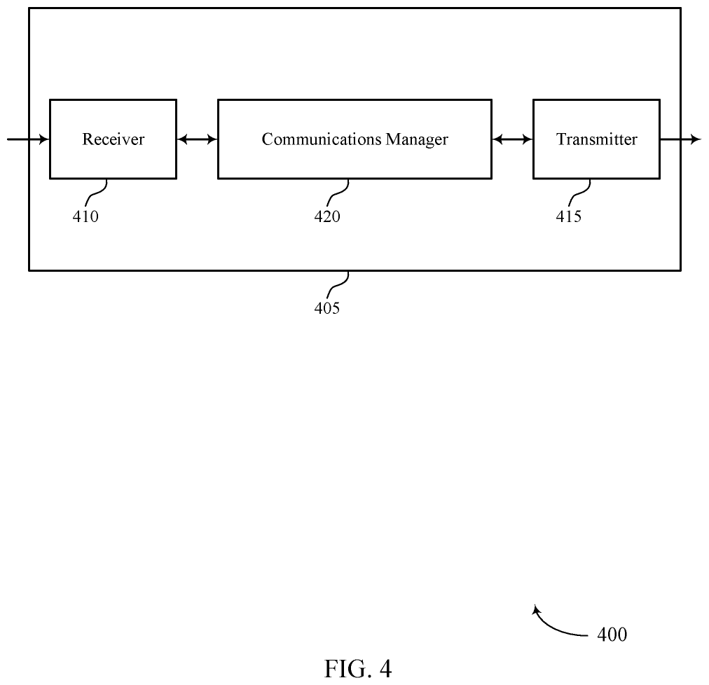

FIG. 4 shows a block diagram 400 of a device 405 that supports adaptive uplink transmission skipping in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to adaptive uplink transmission skipping). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to adaptive uplink transmission skipping). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of adaptive uplink transmission skipping as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, in some examples, the communications manager 420, the receiver 410, the transmitter 415, or various combinations or components thereof may be implemented in code (e.g., as communications management software or firmware) executed by a processor (e.g., referred to as processor-executable code). If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications at a UE in accordance with examples as disclosed herein. For example, the communications manager 420 is capable of, configured to, or operable to support a means for receiving control signaling configuring the UE to skip uplink transmission when the UE does not have data to transmit. The communications manager 420 is capable of, configured to, or operable to support a means for receiving a grant for uplink resources. The communications manager 420 is capable of, configured to, or operable to support a means for transmitting, when the UE does not have data to transmit, an uplink message via the uplink resources based on traffic characteristics of the UE or a type of an application operating at the UE, the uplink message including null data.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for reduced latency and improved performance for applications and flows with stringent requirements.

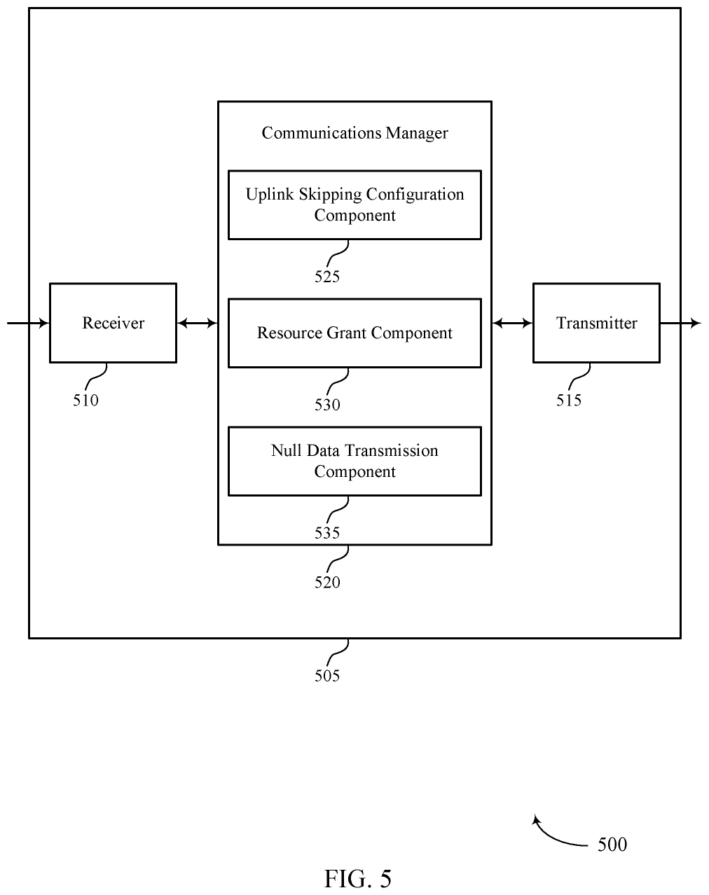

FIG. 5 shows a block diagram 500 of a device 505 that supports adaptive uplink transmission skipping in accordance with one or more aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to adaptive uplink transmission skipping). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to adaptive uplink transmission skipping). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of adaptive uplink transmission skipping as described herein. For example, the communications manager 520 may include an uplink skipping configuration component 525, a resource grant component 530, a null data transmission component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. The uplink skipping configuration component 525 is capable of, configured to, or operable to support a means for receiving control signaling configuring the UE to skip uplink transmission when the UE does not have data to transmit. The resource grant component 530 is capable of, configured to, or operable to support a means for receiving a grant for uplink resources. The null data transmission component 535 is capable of, configured to, or operable to support a means for transmitting, when the UE does not have data to transmit, an uplink message via the uplink resources based on traffic characteristics of the UE or a type of an application operating at the UE, the uplink message including null data.

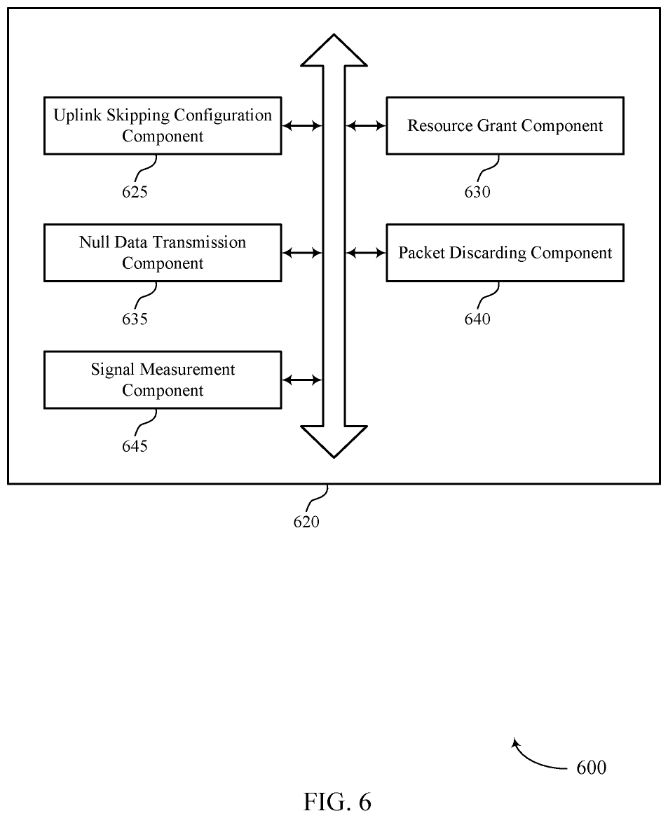

FIG. 6 shows a block diagram 600 of a communications manager 620 that supports adaptive uplink transmission skipping in accordance with one or more aspects of the present disclosure. The communications manager 620 may be an example of aspects of a communications manager 420, a communications manager 520, or both, as described herein. The communications manager 620, or various components thereof, may be an example of means for performing various aspects of adaptive uplink transmission skipping as described herein. For example, the communications manager 620 may include an uplink skipping configuration component 625, a resource grant component 630, a null data transmission component 635, a packet discarding component 640, a signal measurement component 645, or any combination thereof. Each of these components may communicate, directly or indirectly, with one another (e.g., via one or more buses).

The communications manager 620 may support wireless communications at a UE in accordance with examples as disclosed herein. The uplink skipping configuration component 625 is capable of, configured to, or operable to support a means for receiving control signaling configuring the UE to skip uplink transmission when the UE does not have data to transmit. The resource grant component 630 is capable of, configured to, or operable to support a means for receiving a grant for uplink resources. The null data transmission component 635 is capable of, configured to, or operable to support a means for transmitting, when the UE does not have data to transmit, an uplink message via the uplink resources based on traffic characteristics of the UE or a type of an application operating at the UE, the uplink message including null data.

In some examples, to support transmitting the uplink message, the null data transmission component 635 is capable of, configured to, or operable to support a means for transmitting the uplink message based on a type of an application operating at the UE, where the traffic characteristics include the type of the application.

In some examples, the application operating at the UE discards one or more packets based on a latency requirement of the application.

In some examples, the packet discarding component 640 is capable of, configured to, or operable to support a means for discarding packets for an application at a rate above a threshold, where transmitting the uplink message is based on the rate being above the threshold.

In some examples, to support transmitting the uplink message, the null data transmission component 635 is capable of, configured to, or operable to support a means for transmitting the uplink message based on a traffic type of traffic associated with a flow of the UE, where the traffic characteristics include the traffic type. In some examples, the traffic type is based on header information of the traffic.

In some examples, to support transmitting the uplink message, the null data transmission component 635 is capable of, configured to, or operable to support a means for transmitting the uplink message based on a latency requirement for traffic of the UE, where the traffic characteristics include the latency requirement.

In some examples, to support transmitting the uplink message, the null data transmission component 635 is capable of, configured to, or operable to support a means for transmitting the uplink message based on a packet discard timer at the UE being active.

In some examples, to support transmitting the uplink message, the null data transmission component 635 is capable of, configured to, or operable to support a means for transmitting the uplink message based on a PDCP PDU recovery procedure at the UE.

In some examples, to support transmitting the uplink message, the null data transmission component 635 is capable of, configured to, or operable to support a means for transmitting the uplink message based on the UE performing a Transmission Control Protocol slow start procedure, where the traffic characteristics include the Transmission Control Protocol slow start procedure.

In some examples, to support transmitting the uplink message, the null data transmission component 635 is capable of, configured to, or operable to support a means for transmitting the uplink message based on the UE performing a duplicate acknowledgment procedure, where the traffic characteristics include the duplicate acknowledgment procedure.

In some examples, the signal measurement component 645 is capable of, configured to, or operable to support a means for measuring reference signals to obtain a reference signal received power measurement, where transmitting the uplink message is based on the reference signal received power measurement failing to satisfy a threshold, and where the traffic characteristics include the reference signal received power measurement failing to satisfy the threshold.

In some examples, the signal measurement component 645 is capable of, configured to, or operable to support a means for measuring reference signals to obtain a pathloss measurement, where transmitting the uplink message is based on the pathloss measurement failing to satisfy a threshold, and where the traffic characteristics include the pathloss measurement failing to satisfy the threshold.

In some examples, to support transmitting the uplink message, the null data transmission component 635 is capable of, configured to, or operable to support a means for transmitting the uplink message based on satisfying a Radio Link Control retransmission threshold, where the traffic characteristics include the satisfying the Radio Link Control retransmission threshold.

In some examples, to support transmitting the uplink message, the null data transmission component 635 is capable of, configured to, or operable to support a means for transmitting the uplink message based on the traffic characteristics satisfying thresholds associated with mobility procedures at the UE.

In some examples, to support receiving the grant, the resource grant component 630 is capable of, configured to, or operable to support a means for receiving a dynamic grant indicating the uplink resources for the uplink transmission, where the grant includes the dynamic grant.

In some examples, to support receiving the grant, the resource grant component 630 is capable of, configured to, or operable to support a means for receiving a configured grant indicating periodic uplink resources, where the uplink resources for the uplink transmission correspond to an occasion of the periodic uplink resources.

In some examples, to support transmitting the uplink message, the null data transmission component 635 is capable of, configured to, or operable to support a means for transmitting the uplink message based on a determination that the UE is operating in a first state of multiple states, the multiple states including a small data transmission state and a non-small data transmission state.

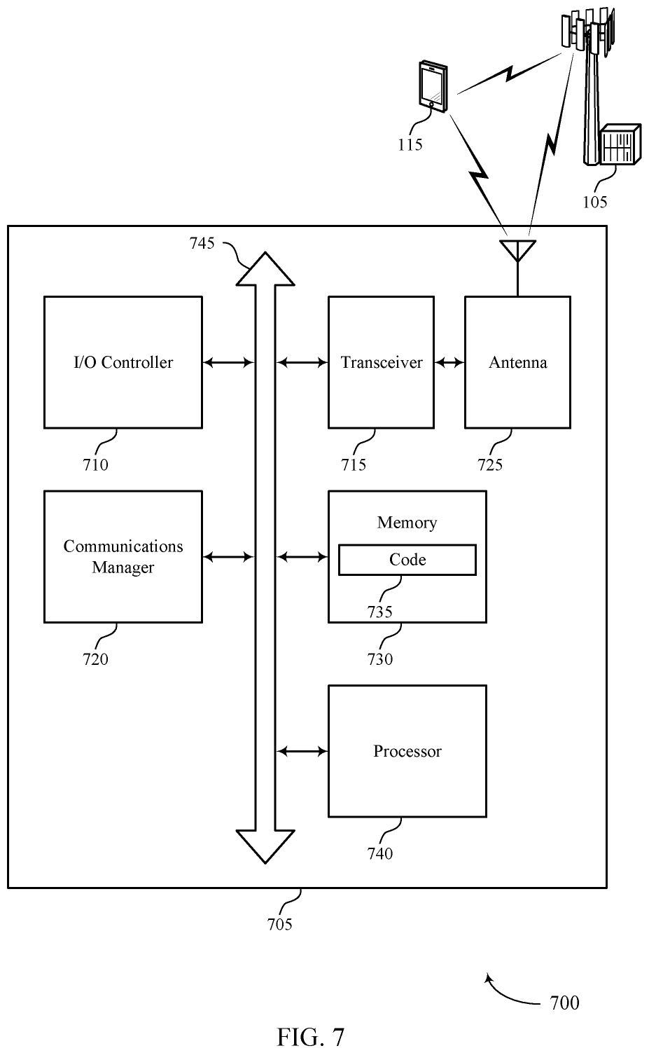

FIG. 7 shows a diagram of a system 700 including a device 705 that supports adaptive uplink transmission skipping in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the at least one processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may contain, among other things, a basic I/O system (BIOS) which may control basic hardware or software operation such as the interaction with peripheral components or devices.

The at least one processor 740 may include one or more intelligent hardware devices (e.g., a general-purpose processor, a DSP, a CPU, one or more graphics processing units (GPUs), a microcontroller, an ASIC, an FPGA, a programmable logic device, a discrete gate or transistor logic component, a discrete hardware component, or any combination thereof). In some cases, the at least one processor 740 may be configured to operate a memory array using a memory controller. In some other cases, a memory controller may be integrated into the at least one processor 740. In some examples, the at least one processor 740 may include multiple processors and the at least one memory 730 may include multiple memories. One or more of the multiple processors may be coupled with one or more of the multiple memories, which may, individually or collectively, be configured to perform various functions described herein. The at least one processor 740 may be configured to execute computer-readable instructions stored in a memory (e.g., the at least one memory 730) to cause the device 705 to perform various functions (e.g., functions or tasks supporting adaptive uplink transmission skipping). For example, the device 705 or a component of the device 705 may include at least one processor 740 and at least one memory 730 coupled with or to the at least one processor 740, the at least one processor 740 and at least one memory 730 configured to perform various functions described herein.

The communications manager 720 may support wireless communications at a UE in accordance with examples as disclosed herein. For example, the communications manager 720 is capable of, configured to, or operable to support a means for receiving control signaling configuring the UE to skip uplink transmission when the UE does not have data to transmit. The communications manager 720 is capable of, configured to, or operable to support a means for receiving a grant for uplink resources. The communications manager 720 is capable of, configured to, or operable to support a means for transmitting, when the UE does not have data to transmit, an uplink message via the uplink resources based on traffic characteristics of the UE or a type of an application operating at the UE, the uplink message including null data.

By including or configuring the communications manager 720 in accordance with examples as described herein, the device 705 may support techniques for reduced latency and improved performance for applications and flows with stringent requirements.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of adaptive uplink transmission skipping as described herein, or the at least one processor 740 and the at least one memory 730 may be otherwise configured to perform or support such operations.

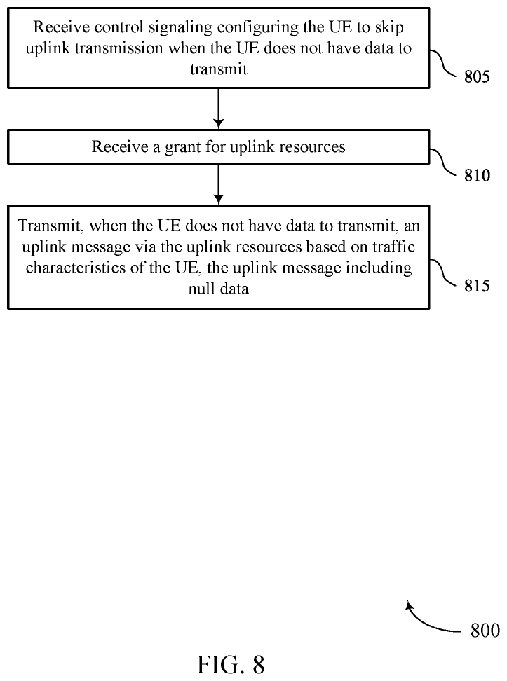

FIG. 8 shows a flowchart illustrating a method 800 that supports adaptive uplink transmission skipping in accordance with aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include receiving control signaling configuring the UE to skip uplink transmission when the UE does not have data to transmit. The operations of 805 may be performed in accordance with examples as disclosed herein. In some examples, aspects of the operations of 805 may be performed by an uplink skipping configuration component 625 as described with reference to FIG. 6.

At 810, the method may include receiving a grant for uplink resources. The operations of 810 may be performed in accordance with examples as disclosed herein. In some examples, aspects of the operations of 810 may be performed by a resource grant component 630 as described with reference to FIG. 6.

At 815, the method may include transmitting, when the UE does not have data to transmit, an uplink message via the uplink resources based on traffic characteristics of the UE, the uplink message including null data. The operations of 815 may be performed in accordance with examples as disclosed herein. In some examples, aspects of the operations of 815 may be performed by a null data transmission component 635 as described with reference to FIG. 6.

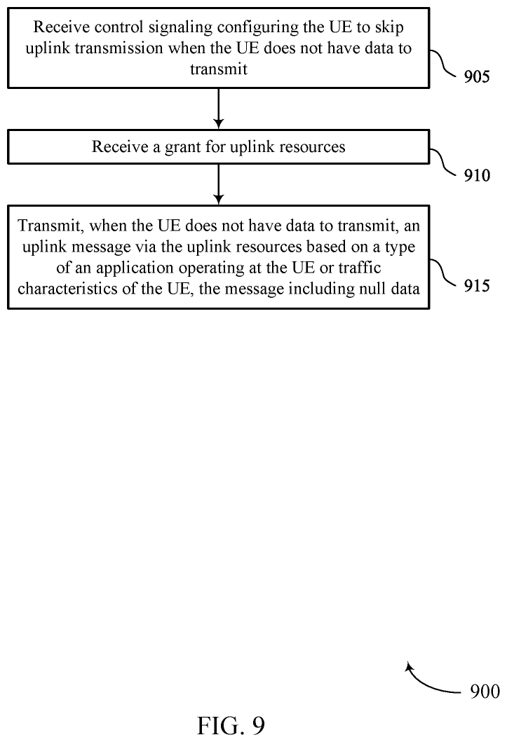

FIG. 9 shows a flowchart illustrating a method 900 that supports adaptive uplink transmission skipping in accordance with aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include receiving control signaling configuring the UE to skip uplink transmission when the UE does not have data to transmit. The operations of 905 may be performed in accordance with examples as disclosed herein. In some examples, aspects of the operations of 905 may be performed by an uplink skipping configuration component 625 as described with reference to FIG. 6.

At 910, the method may include receiving a grant for uplink resources. The operations of 910 may be performed in accordance with examples as disclosed herein. In some examples, aspects of the operations of 910 may be performed by a resource grant component 630 as described with reference to FIG. 6.

At 915, the method may include transmitting, when the UE does not have data to transmit, an uplink message via the uplink resources based on a type of an application operating at the UE or traffic characteristics of the UE, the uplink message including null data. The operations of 915 may be performed in accordance with examples as disclosed herein. In some examples, aspects of the operations of 915 may be performed by a null data transmission component 635 as described with reference to FIG. 6.

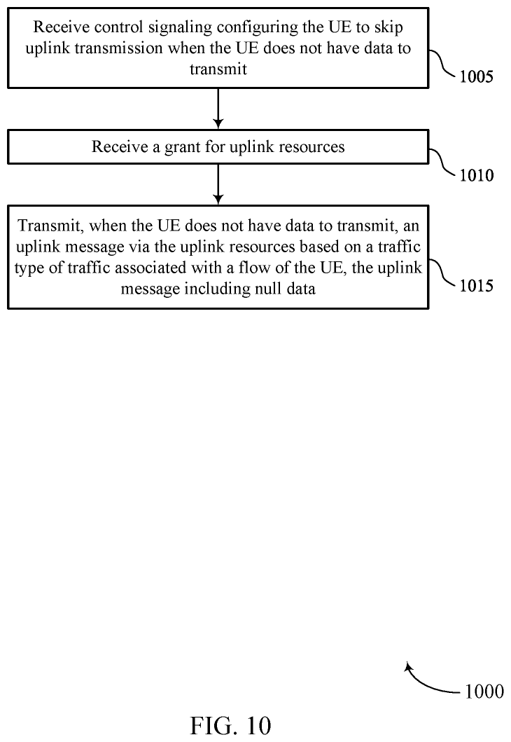

FIG. 10 shows a flowchart illustrating a method 1000 that supports adaptive uplink transmission skipping in accordance with aspects of the present disclosure. The operations of the method 1000 may be implemented by a UE or its components as described herein. For example, the operations of the method 1000 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1005, the method may include receiving control signaling configuring the UE to skip uplink transmission when the UE does not have data to transmit. The operations of 1005 may be performed in accordance with examples as disclosed herein. In some examples, aspects of the operations of 1005 may be performed by an uplink skipping configuration component 625 as described with reference to FIG. 6.

At 1010, the method may include receiving a grant for uplink resources. The operations of 1010 may be performed in accordance with examples as disclosed herein. In some examples, aspects of the operations of 1010 may be performed by a resource grant component 630 as described with reference to FIG. 6.

At 1015, the method may include transmitting, when the UE does not have data to transmit, an uplink message via the uplink resources based on a traffic type of traffic associated with a flow of the UE, the uplink message including null data. The operations of 1015 may be performed in accordance with examples as disclosed herein. In some examples, aspects of the operations of 1015 may be performed by a null data transmission component 635 as described with reference to FIG. 6.

The following provides an overview of aspects of the present disclosure:

Aspect 1: A method for wireless communications at a UE, comprising: receiving control signaling configuring the UE to skip uplink transmission when the UE does not have data to transmit; receiving a grant for uplink resources; and transmitting, when the UE does not have data to transmit, an uplink message via the uplink resources based at least in part on traffic characteristics of the UE or a type of an application operating at the UE, the uplink message comprising null data.

Aspect 2: The method of aspect 1, wherein transmitting the uplink message comprises: transmitting the uplink message based at least in part on the type of the application operating at the UE.

Aspect 3: The method of aspect 2, wherein the application operating at the UE discards one or more packets based at least in part on a latency requirement of the application.

Aspect 4: The method of any of aspects 1 through 3, further comprising: discarding packets for the application at a rate above a threshold, wherein transmitting the uplink message is based at least in part on the rate being above the threshold.

Aspect 5: The method of any of aspects 1 through 4, wherein transmitting the uplink message comprises: transmitting the uplink message based at least in part on a traffic type of traffic associated with a flow of the UE, wherein the traffic characteristics comprise the traffic type.

Aspect 6: The method of aspect 5, wherein the traffic type is based on header information of the traffic.

Aspect 7: The method of any of aspects 1 through 6, wherein transmitting the uplink message comprises: transmitting the uplink message based at least in part on a latency requirement for traffic of the UE, wherein the traffic characteristics comprise the latency requirement.

Aspect 8: The method of any of aspects 1 through 7, wherein transmitting the uplink message comprises: transmitting the uplink message based at least in part on a packet discard timer at the UE being active.

Aspect 9: The method of any of aspects 1 through 8, wherein transmitting the uplink message comprises: transmitting the uplink message based at least in part on a Packet Data Convergence Protocol (PDCP) Protocol Data Unit (PDU) recovery procedure at the UE.

Aspect 10: The method of any of aspects 1 through 9, wherein transmitting the uplink message comprises: transmitting the uplink message based at least in part on the UE performing a Transmission Control Protocol slow start procedure, wherein the traffic characteristics comprise the Transmission Control Protocol slow start procedure.

Aspect 11: The method of any of aspects 1 through 10, wherein transmitting the uplink message comprises: transmitting the uplink message based at least in part on the UE performing a duplicate acknowledgment procedure, wherein the traffic characteristics comprise the duplicate acknowledgment procedure.

Aspect 12: The method of any of aspects 1 through 11, further comprising:
measuring reference signals to obtain a reference signal received power measurement, wherein transmitting the uplink message is based at least in part on the reference signal received power measurement failing to satisfy a threshold, and wherein the traffic characteristics comprise the reference signal received power measurement failing to satisfy the threshold.

Aspect 13: The method of any of aspects 1 through 12, further comprising: measuring reference signals to obtain a pathloss measurement, wherein transmitting the uplink message is based at least in part on the pathloss measurement failing to satisfy a threshold, and wherein the traffic characteristics comprise the pathloss measurement failing to satisfy the threshold.

Aspect 14: The method of any of aspects 1 through 13, wherein transmitting the uplink message comprises: transmitting the uplink message based at least in part on satisfying a Radio Link Control retransmission threshold, wherein the traffic characteristics comprise the satisfying the Radio Link Control retransmission threshold.

Aspect 15: The method of any of aspects 1 through 14, wherein transmitting the uplink message comprises: transmitting the uplink message based at least in part on the traffic characteristics satisfying thresholds associated with mobility procedures at the UE.

Aspect 16: The method of any of aspects 1 through 15, wherein receiving the grant comprises: receiving a dynamic grant indicating the uplink resources for the uplink transmission, wherein the grant comprises the dynamic grant.

Aspect 17: The method of any of aspects 1 through 16, wherein receiving the grant comprises: receiving a configured grant indicating periodic uplink resources, wherein the uplink resources for the uplink transmission correspond to an occasion of the periodic uplink resources.

Aspect 18: The method of any of aspects 1 through 17, wherein transmitting the uplink message comprises: transmitting the uplink message based on a determination that the UE is operating in a first state of multiple states, the multiple states including a small data transmission state and a non-small data transmission state.

Aspect 19: An apparatus for wireless communications at a UE, comprising a processor; memory coupled with the processor; and instructions stored in the memory and executable by the processor to cause the apparatus to perform a method of any of aspects 1 through 18.

Aspect 20: An apparatus for wireless communications at a UE, comprising at least one means for performing a method of any of aspects 1 through 18.

Aspect 21: A non-transitory computer-readable medium storing code for wireless communications at a UE, the code comprising instructions executable by a processor to perform a method of any of aspects 1 through 18.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The article “a” as used in the claims shall be understood to refer to one or more than one of the specified components. Thus, the terms “a,” “at least one,” and “one or more” are to be construed to be interchangeable. Subsequent reference to a component introduced with the article “a” using the terms “the” or “said” shall be construed as referring to any or all of the one or more components. That is, a component introduced with the article “a” shall be understood to mean “one or more components,” and referring to “the component” subsequently in the claims shall be understood to be equivalent to referring to “the one or more components.”

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling configuring the UE to skip uplink transmission when the UE does not have data to transmit;
receive a grant for uplink resources; and
transmit, when the UE does not have data to transmit, an uplink message via the uplink resources based at least in part on traffic characteristics of the UE or a type of an application operating at the UE, the uplink message comprising null data.

2. The UE of claim 1, wherein the application operating at the UE discards one or more packets based at least in part on a latency requirement of the application.

3. The UE of claim 1, wherein the one or more processors are individually or collectively operable to execute the code to cause the UE to:
discard packets for the application at a rate above a threshold, wherein transmitting the uplink message is based at least in part on the rate being above the threshold.

4. The UE of claim 1, wherein, to transmit the uplink message, the one or more processors are individually or collectively operable to execute the code to cause the UE to:
transmit the uplink message based at least in part on a traffic type of traffic associated with a flow of the UE, wherein the traffic characteristics comprise the traffic type.

5. The UE of claim 4, wherein the traffic type is based at least in part on header information of the traffic.

6. The UE of claim 1, wherein the one or more processors are individually or collectively operable to execute the code to cause the UE to:
transmit the uplink message based at least in part on a latency requirement for traffic of the UE, wherein the traffic characteristics comprise the latency requirement.

7. The UE of claim 1, wherein, to transmit the uplink message, the one or more processors are individually or collectively operable to execute the code to cause the UE to:
transmit the uplink message based at least in part on a packet discard timer at the UE being active.

8. The UE of claim 1, wherein, transmit the uplink message, the one or more processors are individually or collectively operable to execute the code to cause the UE to:
transmit the uplink message based at least in part on a Packet Data Convergence Protocol (PDCP) Protocol Data Unit (PDU) recovery procedure at the UE.

9. The UE of claim 1, wherein, to transmit the uplink message, the one or more processors are individually or collectively operable to execute the code to cause the UE to:
transmit the uplink message based at least in part on the UE performing a Transmission Control Protocol slow start procedure, wherein the traffic characteristics comprise the Transmission Control Protocol slow start procedure.

10. The UE of claim 1, wherein, to transmit the uplink message, the one or more processors are individually or collectively operable to execute the code to cause the UE to:
transmit the uplink message based at least in part on the UE performing a duplicate acknowledgment procedure, wherein the traffic characteristics comprise the duplicate acknowledgment procedure.

11. The UE of claim 1, wherein the one or more processors are individually or collectively operable to execute the code to cause the UE to:
measure reference signals to obtain a reference signal received power measurement, wherein transmitting the uplink message is based at least in part on the reference signal received power measurement failing to satisfy a threshold, and wherein the traffic characteristics comprise the reference signal received power measurement failing to satisfy the threshold.

12. The UE of claim 1, wherein the one or more processors are individually or collectively operable to execute the code to cause the UE to:
measure reference signals to obtain a pathloss measurement, wherein transmitting the uplink message is based at least in part on the pathloss measurement failing to satisfy a threshold, and wherein the traffic characteristics comprise the pathloss measurement failing to satisfy the threshold.

13. The UE of claim 1, wherein, to transmit the uplink message, the one or more processors are individually or collectively operable to execute the code to cause the UE to:
transmit the uplink message based at least in part on satisfying a Radio Link Control retransmission threshold, wherein the traffic characteristics comprise the satisfying the Radio Link Control retransmission threshold.

14. The UE of claim 1, wherein, to transmit the uplink message, the one or more processors are individually or collectively operable to execute the code to cause the UE to:
transmit the uplink message based at least in part on the traffic characteristics satisfying thresholds associated with mobility procedures at the UE.

15. The UE of claim 1, wherein, to receive the grant, the one or more processors are individually or collectively operable to execute the code to cause the UE to:
receive a dynamic grant indicating the uplink resources for the uplink transmission, wherein the grant comprises the dynamic grant.

16. The UE of claim 1, wherein, to receive the grant, the one or more processors are individually or collectively operable to execute the code to cause the UE to:
receive a configured grant indicating periodic uplink resources, wherein the uplink resources for the uplink transmission correspond to an occasion of the periodic uplink resources.

17. The UE of claim 1, wherein, to transmit the uplink message, the one or more processors are individually or collectively operable to execute the code to cause the UE to:
transmit the uplink message based at least in part on a determination that the UE is operating in a first state of a plurality of states, the plurality of states comprising a small data transmission state and a non-small data transmission state.

18. A method for wireless communications at a user equipment (UE), comprising:
receiving control signaling configuring the UE to skip uplink transmission when the UE does not have data to transmit;
receiving a grant for uplink resources; and
transmitting, when the UE does not have data to transmit, an uplink message via the uplink resources based at least in part on traffic characteristics of the UE or a type of an application operating at the UE, the uplink message comprising null data.

19. The method of claim 18, wherein transmitting the uplink message comprises:
transmitting the uplink message based at least in part on a traffic type of traffic associated with a flow of the UE, wherein the traffic characteristics comprise the traffic type.

20. An apparatus for wireless communications at a user equipment (UE), comprising:
means for receiving control signaling configuring the UE to skip uplink transmission when the UE does not have data to transmit;
means for receiving a grant for uplink resources; and
means for transmitting, when the UE does not have data to transmit, an uplink message via the uplink resources based at least in part on traffic characteristics of the UE or a type of an application operating at the UE, the uplink message comprising null data.
